(19) United States
(12) Patent Application Publication
(10) Pub. No.: US 2010/0281687 A1
(43) Pub. Date: Nov. 11, 2010

(54) METHOD AND SYSTEM FOR ELECTRICALLY COUPLIING AN INFORMATION CARRIER TO A CONTACT ELEMENT

(76) Inventors: Gabor Karacs, Chemnitz (DE); Tino Zillger, Chemnitz (DE); Thoralt Franz, Zwonitz (DE)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/377,483

(22) PCT Filed: Jul. 13, 2007
(86) PCT No.: PCT/EP2007/057234

§ 371 Date: Jul. 28, 2010

(30) Foreign Application Priority Data
Aug. 25, 2006 (DE) 102006039929.3

(51) Int. Cl. H01R 43/20

(52) U.S. Cl. 29/876; 29/729

(57) ABSTRACT

The invention relates to a method and to a system for electrically coupling an information carrier to a contact element, wherein the information carrier has a conductor tract structure with a contact zone, which is embedded between two substrate layers, which are connect firmly to one another, and the contact element is brought into electrical contact with the contact zone. The information carrier is in this case first cut or stamped in such a way that the contact zone is exposed in an edge region and then the contact element is brought into electrical contact with the contact zone in this edge region.

The invention relates to a method and a system for electrically coupling an information carrier to a contact element, the information carrier having a conductor track structure with a contact zone which is embedded between two substrate layers which are connected firmly to each other, and the contact element being brought into electrical contact with the contact zone.

It is known from DE-A-10 2005 042 089 to produce an internal electrically conductive structure in such a manner that such structures are printed with a conductive printing substance onto a substrate, for example paper or film, and are then laminated together with a covering substrate. The conductor track structure so produced therefore lies on the inside between two substrate layers, additional adhesive being present. This construction is advantageous for various applications, such as, for example, keypads made of paper, playing cards having an electrical storage structure, etc. However, this configuration involves the problem of introducing electrical signals, or current, into the conductor track structure.

The object of the invention is therefore to provide a simple and reliable possibility for electrically coupling the information carrier to a contact element.

This object is achieved according to the invention by the features of claims 1 and 6.

In the method according to the invention for electrically coupling an information carrier to a contact element, the information carrier has a conductor track structure with a contact zone which is embedded between two substrate layers which are connected firmly to each other. In a first step of the method, the information carrier is first of all cut or stamped in such a manner that the contact zone is exposed in an edge region. Then the contact element is brought into electrical contact with the contact zone in that edge region.

In the system according to the invention for electrically contacting an information carrier with a contact element, a cutting or stamping device is provided for the purpose in order to expose the embedded contact zone in an edge region. Furthermore, the contact element is in a form for electrically contacting the exposed contact zone.

As a result of exposing the contact zone in an edge region of the information carrier, the contact element can be brought into electrical contact with the contact zone in a simple manner.

Further configurations of the invention are the subject matter of the subordinate claims.

According to a preferred embodiment, the contact element is pressed against the contact zone during the electrical contacting operation. For example, an ohmic contact, an electrostatic contact or an electromagnetic contact can be formed.

The contact zone exposed in the edge region may, in particular, be constructed to be planar, linear or punctiform.

According to a preferred configuration, the conductor track structure and the contact zone (before the cutting or stamping operation) are embedded invisibly between two flexible substrate layers; in particular, paper and film come into consideration as substrate layers. The two substrate layers can be brought together, for example, by lamination.

Further advantages and configurations of the invention will be explained in more detail hereinafter by means of the description and the drawings.

### IN THE DRAWINGS

FIG. 1 is a three-dimensional representation of the information carrier,

FIG. 2 is a diagrammatic side view of the information carrier before the cutting or stamping operation,

FIG. 3 is a diagrammatic view of the information carrier shortly before contacting takes place and

FIG. 4 is a diagrammatic side view of the information carrier during the contacting operation.

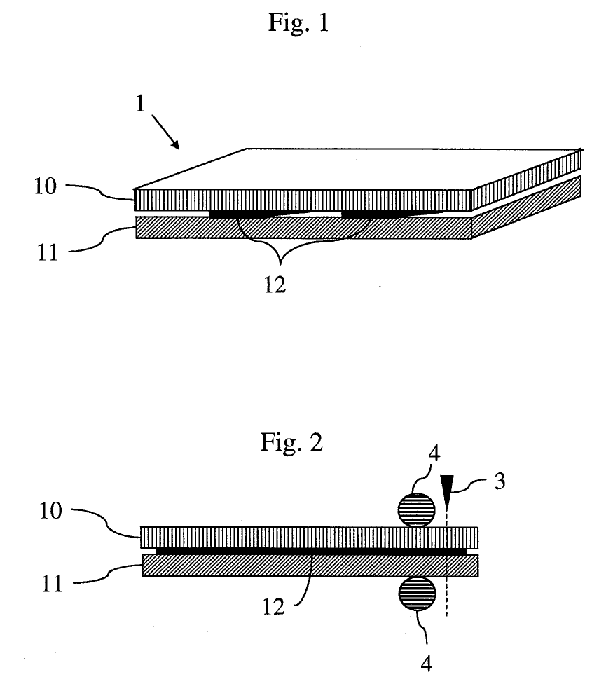

The information carrier shown in FIG. 1 consists substantially of two flexible substrate layers 10, 11 which are connected firmly to each other, and a conductor track structure 12 embedded between the two substrate layers.

The two substrate layers 10, 11 are composed, for example, of paper or film, the conductor track structure being embedded invisibly between the two substrate layers. The conductor track structure is applied in a suitable manner to one of the substrate layers. The use of conductive organic polymers, especially PEDOT or PANI, has proved to be especially advantageous here. These conductive organic polymers can be printed onto the substrate layer in a simple manner. In particular, mass printing processes, such as letterpress, intaglio or planographic printing processes, may be used. When the conductor track structure has been printed, the two substrate layers 10, 11 are joined together in a suitable manner, for example by lamination.

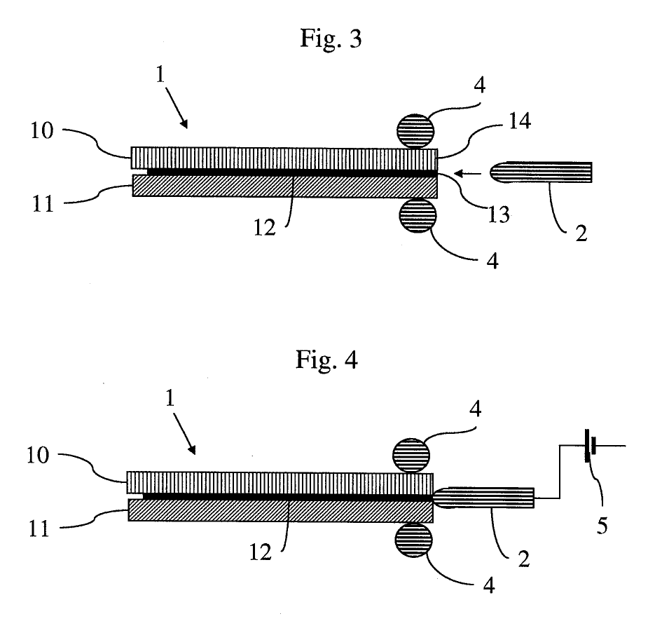

For the electrical coupling of the information carrier 1 to a contact element 2 (see FIG. 3), the conductor track structure has a contact zone 13 which is to be exposed by cutting or stamping the information carrier 1 before contacting takes place.

The system for electrically contacting the information carrier with the contact element 2 therefore has a cutting or stamping device 3 (see FIG. 2). By means of a suitable guiding and holding device 4, the information carrier 1 can be cut or stamped in such a manner that the contact zone 13 is exposed in an edge region 14.

When the contact zone 13 has been exposed, the contact element 2 is pressed against the contact zone (see FIG. 3). Using a current/voltage source 5, a current or a voltage is applied to the contact element 2 in order to introduce a corresponding signal into the conductor track structure.

In particular, an ohmic contact, an electrostatic contact or an electromagnetic contact can in principle be formed between the contact zone 13 and the contact element 2. The contact zone 13 exposed in the edge region 14 is to be constructed in a suitable manner. In particular, a planar, linear or punctiform construction comes into consideration. Using the system/method described above, a conductor track structure embedded between two substrate layers can be contacted in a simple and reliable manner.

If the information carrier is an entrance ticket for an event, a visible cancellation of the entrance ticket is effected by the cutting or stamping operation at the same time.

1. Method for electrically coupling an information carrier to a contact element, the information carrier having a conductor track structure with a contact zone, the conductor track structure and the contact zone being embedded invisibly between two substrate layers which are connected firmly to each other, and the contact element being brought into electrical contact with the contact zone, wherein the information carrier, in order to produce an electrical coupling, is, in a contacting system, first of all cut or stamped in such a manner that the contact zone is exposed in an edge region, and then the contact element is brought into ohmic contact with the contact zone in that edge region.

2. Method according to claim 1, wherein the contact element is pressed against the contact zone during the electrical contacting operation.

3. (canceled)

4. (canceled)

5. (canceled)

6. System for electrically contacting an information carrier, which has a conductor track structure with a contact zone, the conductor track structure and the contact zone being embedded invisibly between two substrate layers which are connected firmly to each other, the system containing
a guiding and holding device for the information carrier;
a cutting or stamping device for exposing the embedded contact zone in an edge region, and of the information carrier;
a contact element ohmically contacting the exposed contact zone; and
a current/voltage source for applying a current or a voltage to the contact element and for introducing a corresponding signal into the conductor track structure.

7. (canceled)

8. (canceled)

9. (canceled)

10. System according to claim 6, wherein the substrate layers are composed of paper or film.

11. (canceled)

12. System according to claim 6, wherein the two substrate layers are joined together by lamination.

13. System according to claim 6, wherein the information carrier is constructed to be flexible.

14. System according to claim 6, wherein the conductor track structure and the contact zone are composed of conductive organic polymers, selected from the group consisting of PEDOT and PANI.

15. System according to claim 14, wherein the conductive organic polymers are produced by a mass printing process, selected from the group consisting of a letterpress, intaglio and planographic printing process.

16. Method according to claim 1, wherein the information carrier is guided and held in the contacting system during the cutting or stamping operation and during the contacting with the contact element.

17. Method for electrically coupling an entrance ticket to a contact element and for cancelling the entrance ticket, the entrance ticket having a conductor track structure with a contact zone, the conductor track structure and the contact zone being embedded invisibly between two substrate layers, which are connected firmly to each other, and the contact element being brought into electrical contact with the contact zone, wherein the contact zone of the entrance ticket is first of all, in a contacting system, exposed in an edge region by a cutting or stamping operation and then the contact element is brought into ohmic contact with the contact zone in that edge region, the entrance ticket being visibly cancelled by the cutting or stamping operation.

18. System according claim 10, wherein the two substrate layers are joined together by lamination.

19. System according to claim 18, wherein the information carrier is constructed to be flexible.

20. System according to 19, wherein the conductor track structure and the contact zone are composed of conductive organic polymers.
